(19) United States
(12) Patent Application Publication
(10) Pub. No.: US 2008/0060211 A1
(43) Pub. Date: Mar. 13, 2008

(54) DEVICE FOR STORING AND DRYING A FISHING REEL

(76) Inventors: Wallace J. Paradis, Plantation, FL (US); Noel C. Duncan, Plantation, FL (US)

Correspondence Address: LAW OFFICE OF STEVEN B. LEAVITT, L.L.P., 130 Meadowcreek, Rockwall, TX, 75032, US

(21) Appl. No.: 11/531,693

(22) Filed: Sep. 13, 2006

(51) Int. Cl. F26B 25/06

(52) U.S. Cl. 34/202; 34/201; 34/104

(57) ABSTRACT

The present is directed to a device for storing and drying a fishing reel wherein the device includes a housing having a top wall, a bottom wall, and at least one side wall, wherein the top wall, bottom wall, and at least one side wall define an interior space. The top wall and the bottom wall each contain a corresponding orifice wherein the diameter of a fishing rod fits within each orifice. The device also includes at least one fan for blowing air into the housing and drying a fishing reel located in the interior space of the housing.

### BACKGROUND OF THE INVENTION

1. Technical Field

This invention relates to storage devices, and more particularly, to a device for drying and storing a fishing reel.

2. Description of Related Art

Fishing is a very ancient practice that dates back at least to the Mesolithic period which began about 10,000 years ago. During that time, fishing was done out of necessity for food and involved either a simple net or a hook on a line. Since then, a portion of fishing has evolved into a recreational activity done for pleasure or competition. The equipment used has become very sophisticated and relatively expensive, especially for saltwater fishing.

One of the drawbacks of saltwater fishing is that during the normal course of activity, rods and reels are exposed to salt water, dirt, and other debris. As a result, fishing reel corrosion is a common problem. If the fishing rod and reel are not properly cleaned immediately after use, degradation of the rods and reels will occur as the saltwater has a highly corrosive effect on the materials comprising the rods and reels. In addition, after both freshwater and saltwater fishing, often the fishing rod and reel are not dried immediately by the user following activity, which results in rusting and other corrosion of the rod or reel.

Each of the above factors causes irreparable damage to the fishing rod and reel such that it wreaks havoc with the gears, bearings and other working parts of the rod and reel. Such damage often requires premature replacement of the rod and reel which can be relatively expensive. What is needed is a device that helps to ensure proper care and maintenance of fishing equipment such as rods and reels. Furthermore, a device is needed that also can be used to store the rode and reel until their next use.

### SUMMARY OF INVENTION

The present invention solves the above-described problems by providing a device for storing and drying a fishing rod and reel. The device includes a housing having a top wall, a bottom wall, and at least one side wall, wherein the walls define an interior space. The top wall and the bottom wall each contain a corresponding orifice wherein the diameter of a fishing rod fits within each orifice. The device also includes at least one fan for blowing air into the housing thereby drying at least a portion of a rod and a fishing reel located in the interior space of the housing.

More particularly, the housing preferably includes at least two side walls, a back wall, and front door wherein the back wall and front door is disposed between the two side walls. The front door is hinged and can open to allow access to the interior space of the housing. In addition, the top wall and bottom wall may each comprise a second orifice, wherein the second orifice on the top wall corresponds to the second orifice on the bottom wall.

Another aspect of the present invention is directed to a method of cleaning, storing and drying a fishing rod and reel. The method includes rinsing a fishing reel and at least a portion of a fishing rod, preferably with fresh water. The fishing reel and at least a portion of the fishing rod are then placed into a housing. The housing includes a top wall, a bottom wall, and at least one side wall, wherein the walls define an interior space. The top wall and the bottom wall each comprise a corresponding orifice, wherein the fishing rod is placed within each orifice, and wherein the fishing reel and at least a portion of the fishing rod are placed in the interior space of the housing. The fishing reel, and at least a portion of the fishing rod, are dried by blowing air into the housing via a fan attached to the housing.

This process enables, the saltwater, dirt, and other debris on the fishing reel and at least a portion of the fishing rod to be rinsed off preferably with fresh water. Then, to help prevent rusting and corrosion, the fishing reel and a least a portion of the rod is dried for approximately 10 minutes to approximately 1 hour.

Other features and advantages of the present invention will become apparent upon reading the following detailed description of embodiments of the invention, when taken in conjunction with the appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a storage and drying device made in accordance with an embodiment of the present invention;

FIG. 2 is a top view of a storage and drying device made in accordance with an embodiment of the present invention;

FIG. 3 is a side view of a storage and drying device made in accordance with an embodiment of the present invention; and

FIG. 4 is a flow diagram depicting the steps used in accordance with an embodiment of the present invention.

### DETAILED DESCRIPTION OF THE INVENTION

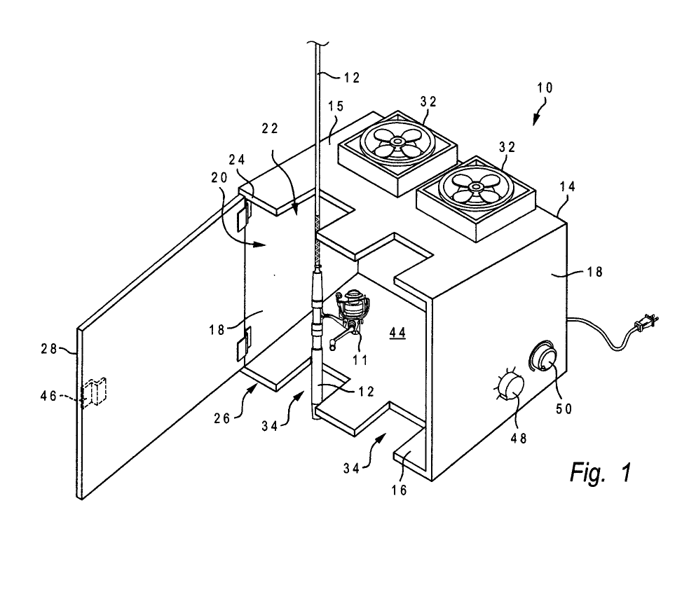

Referring to FIG. 1, shown is a device 10 for storing and drying a fishing reel 11 and rod 12. Device 10 includes housing 14 having top wall 15, bottom wall 16, and at least one side wall 18. Top walls 15, bottom wall 16 and at least one side wall 18 define interior space 20. Top wall 15 contains top orifice 22 which corresponds to or is in alignment with bottom orifice 34 located in bottom wall 16. Top orifice 22 and bottom orifice 34 may be any shape and size which allows the diameter of a fishing rod 12 to fit within each orifice. For example, top orifice 22 and bottom orifice 34 may be in the shape of a square, circle, semi circle, oval, etc. Preferably, as shown in FIG. 1 top orifice 22 extends to front edge 24 of top wall 15 and bottom orifice 34 extends to front edge 26 of bottom wall 16 such that the fishing rod 12 may easily be placed within the corresponding orifices.

Preferably, the top wall 15 and bottom wall 16 each comprise more than one top orifice 22 and more than one bottom orifice 34 wherein each more than one top orifice 22 corresponds to, or is in alignment with each more than one bottom orifice 34. Numerous sets of corresponding top orifices 22 and bottom orifices 34 may be located on top wall 15 and bottom wall 16 respectively to accommodate a plurality of fishing rods and reels.

In a preferred embodiment, housing 14 includes two side walls 18, a back wall 44, and front door 28 wherein a back wall 44, and front door 28 are disposed between two side walls 18. Front door 28 may be movably attached to one side walls 18, and serves to open and close housing 14. Front door 28 may also have a handle 46 to assist in opening or closing front door 28.

Housing 14 may be comprised of any material that is water resistant and durable enough to hold rod 12 and reel 11 within housing 14. Suitable materials housing 14 may be comprised of include, but are not limited to plastic, wood, fiberglass, or any other rigid water resistant material. Preferably, device 10 is comprised of plastic.

Preferably, housing 14 has a length between approximately 13 inches and approximately 37 inches, a width or diameter between approximately 16 inches and approximately 32 inches, and a height between approximately 13 inches and approximately 37 inches.

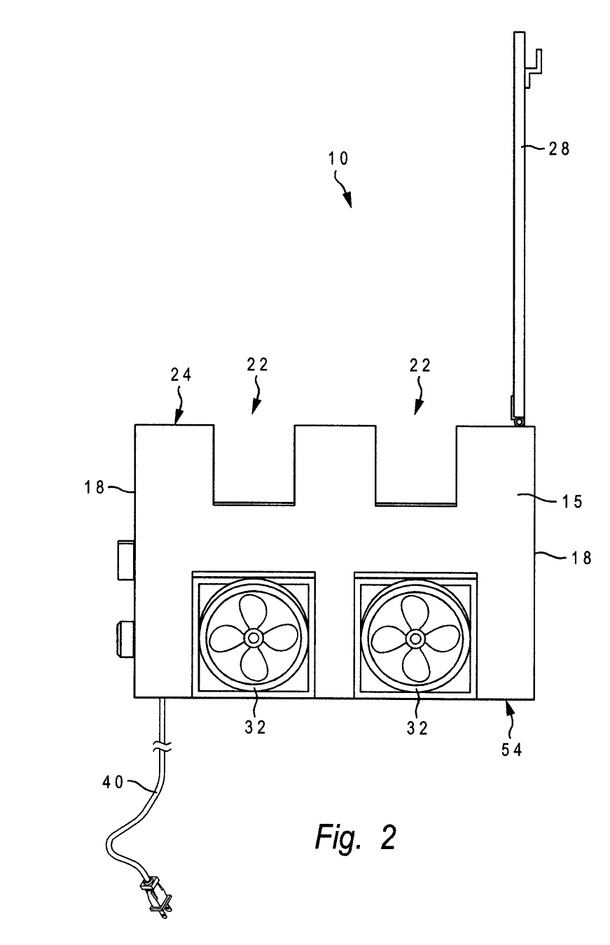

Device 10 also includes at least one fan 32 for blowing air into housing 14 to dry fishing reel 11 and a portion of fishing rod 12 located in interior space 20 of housing 14. Preferably, device 10 includes two fans 32, each attached to top wall 15 of housing 14. Desirably, fans 32 are located proximate to back edge 34 of top wall 15, as shown in FIG. 2. While fan 56 is shown extending from top wall 34, fan 56 may be flush with top wall 34.

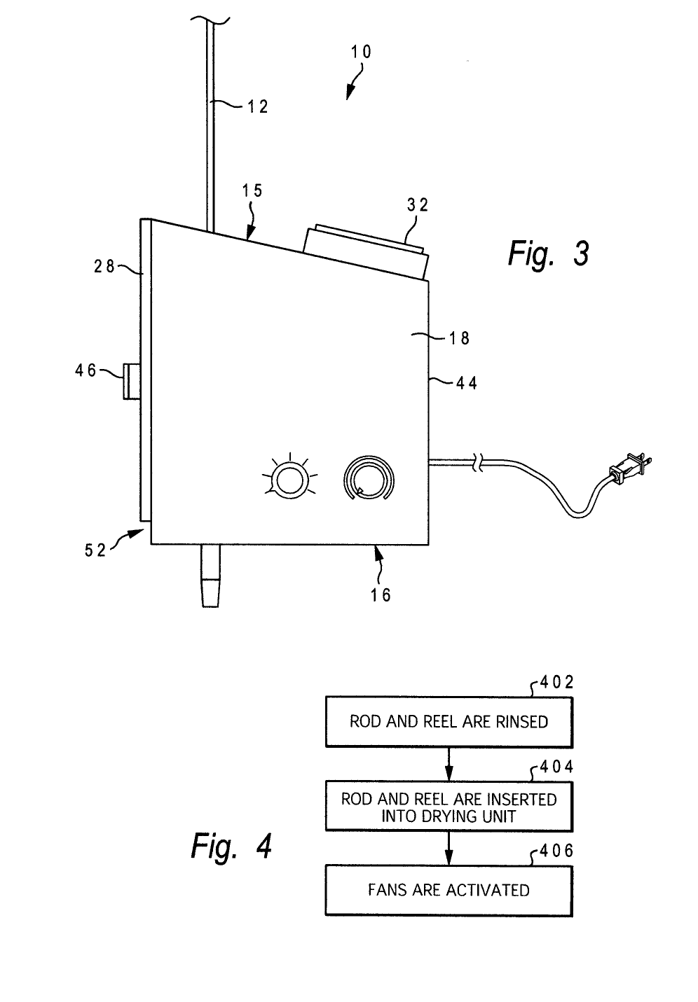

In addition, as shown in FIG. 3, the top wall 15 may have a downward slope from front to back wherein fan 32 is positioned at an angle to provide direct air flow on fishing reel 11 and rod 12 located within housing 14. Fans 32 may be attached or mounted to housing 14 by any means known to those skilled in the art. In addition, any type of fan 32 may be used in device 10 of the present invention which is capable of effectively drying fishing reel 11 and rod 12 located in housing 14. For example, each fan 32 may have a voltage between approximately 10 volts and approximately 300 volts. Preferably, each fan 32 has a voltage between approximately 12 volts and approximately 220 volts.

In a preferred embodiment, gap 52 is present between front door 28 and bottom wall 16 when front door 28 is in a closed position as shown in FIG. 3. Gap 52 provides an exit for the air flow in the housing 14 created by the fans 32. Preferably, gap 52 is between approximately 1.0 inch and 3.0 inches high.

Device 10 may include timer 48 for setting fan 32 to operate for a predetermined period of time. In addition, device 10 may include fan speed adjuster 50 for regulating the operating speed of fan 32. Timer 48 and fan speed adjuster 50 may each include detailed information regarding the appropriate time setting and speed setting for particular types of rods and reels to be dried. Any timer or fan speed adjuster known to those having skill in the art may be used in the storage and drying device 10 of the present invention.

Housing 14 may include batteries (not shown) to operate fan 32, and/or the housing may include an electrical plug 40 to operate fan 32, as shown in FIG. 2.

The storage and drying device 10 of the present invention is portable, and may be used in any location. Device 10 may also be used to transport fishing rods 12 and reels 11 to a fishing site. In an alternative embodiment, housing 14 may be conveniently placed or mounted on a boat.

As shown in FIG. 4, the present invention is also related to a method of cleaning, storing and drying a fishing rod and reel. After fishing rod 12 and reel 11 have been used, reel and at least a portion of the fishing rod are rinsed to remove salt water, dirt, and any other unwanted residue from the rod and reel, Step 402. Fishing rod 12 and reel 11 may be rinsed with fresh water or any other suitable liquid. This process may be performed for one rod 12 and reel 11 or multiple rods and reels.

Next, each rod 12 is placed into a top orifice 22 located on top wall 15 of housing 14 and into a corresponding bottom orifice 34 located on bottom wall 16 of housing 14, whereby reel 11 and a portion of rod 12 are located within interior space 20 of housing 14, as illustrated in FIG. 1, Step 404. Front door 28 of housing 14 is closed, and fan 32 is activated to dry at least a portion of rod 12 and reel 14 located within housing 14. Fan 32 may be set to operate for a predetermined period of time and/or at a predetermined speed depending upon the type of rod and reel to be dried. On average, reel 11, and portion of rod 12, are dried in the housing for approximately 10 minutes to approximately 1 hour.

It should be understood that the foregoing relates to exemplary embodiments of the invention and that modifications may be made without departing from the spirit and scope of the invention as set forth in the following claims.

What is claimed is:

1. A device for storing and drying a fishing reel comprising:
a housing having a top wall, a bottom wall, and at least one side wall, the walls define an interior space, the top wall and bottom wall each comprise a corresponding orifice wherein the diameter of a fishing rod fits within each orifice; and
at least one fan for blowing air into the housing and drying a fishing reel located in the interior space of the housing.

2. The device of claim 1, wherein the housing comprises at least two side walls, and a back wall and a front door each disposed between the two side walls, and wherein the front door opens and closes the housing.

3. The device of claim 2, wherein a gap exists between the door and the bottom wall when the door is in a closed position.

4. The device of claim 1, wherein the top wall and bottom wall each comprise a second orifice, and the second orifice on the top wall corresponds to the second orifice on the bottom wall.

5. The device of claim 1, wherein the fan is located proximate the top wall of the housing.

6. The device of claim 5, wherein the device comprises two fans for blowing air into the housing.

7. The device of claim 5, wherein the top wall has a downward slope from front to back, and the fan is positioned at an angle to provide direct air flow on the fishing reel.

8. The device of claim 1, wherein the housing has a length between approximately 13 inches and approximately 37 inches, a width or diameter between approximately 16 inches and approximately 32 inches, and a height between approximately 13 inches and approximately 37 inches.

9. The device of claim 1, wherein the device is portable.

10. The device of claim 1, wherein the housing is comprised of plastic, wood, or fiberglass.

11. The device of claim 10, wherein the housing is comprised of plastic.

12. The device of claim 1, wherein the housing further comprises a timer for setting the fan to operate for a predetermined period of time.

13. The device of claim 1, wherein the housing further comprises a fan speed adjuster for regulating the operating speed of the fan.

14. A method of cleaning, storing and drying a fishing reel comprising:
rinsing a fishing reel and at least a portion of a fishing rod;
placing the fishing reel and at least a portion of the fishing rod into a housing, the housing comprising a top wall, a bottom wall, and at least one side wall wherein the walls define an interior space, the top wall and bottom wall each comprise a corresponding orifice, wherein the fishing rod is placed within each orifice, and the fishing reel and at least a portion of the fishing rod is placed in the interior space of the housing; and
drying the fishing reel by blowing air into the housing via a fan attached to the housing.

15. The method of claim 14, wherein the rinsing includes having the fishing reel and at least a portion of the fishing rod rinsed with fresh water.

16. The method of claim 14, wherein the drying includes having the fishing reel dried for approximately 10 minutes to approximately 1 hour.

17. The method of claim 14, wherein the housing comprises at least two side walls, and a back wall and front door each disposed between the two side walls, and wherein the front door opens and closes the housing.

18. The method of claim 17, wherein the housing further comprises a bottom wall and wherein a gap exists between the door and the bottom wall when the door is in a closed position.

19. The method of claim 14, wherein the top wall and bottom wall each comprise a first and second orifice, and the second orifice on the top wall corresponds to the second orifice on the bottom wall.

20. The method of claim 14, wherein the fan is located proximate the top wall of the housing.
